(19) United States
(12) Patent Application Publication
(10) Pub. No.: US 2009/0063088 A1
(43) Pub. Date: Mar. 5, 2009

(54) Wristwatch type acceleration detection module

(76) Inventor: Yu-Yu Chen, Taipei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/896,500

(22) Filed: Sep. 4, 2007

(51) Int. Cl. G01C 22/00; G01P 15/00

(52) U.S. Cl. 702/141; 702/160

(57) ABSTRACT

Disclosed is a wristwatch type acceleration detection module for measurement of exercise quantity, including a microprocessor, an acceleration sensor, a timer, a hand-swing-acceleration-vs-pace-span database, and a display device. The acceleration sensor detects a hand swing count of the user in movement and an acceleration induced by the hand swinging. The timer measures a time period when the user is in movement. The microprocessor receives the hand swing acceleration and the hand-swing-acceleration-vs-pace-span plot stored in the hand-swing-acceleration-vs-pace-span database to obtain the corresponding pace span and further computes a moving distance and a moving speed of the user through predetermined formula based on the pace span, the hand swing count, and the time period of movement of the user.

### FIELD OF THE INVENTION

The present invention relates to a device for measuring exercise quantitatively, and in particular to a wristwatch type acceleration detection module for measurement of exercise quantity.

### BACKGROUND OF THE INVENTION

Modern people living in urban areas put significant emphasis on exercises to keep themselves healthy. Various types of sport and exercise devices are now available in the market to provide the general consumers with measures for doing exercise. Also, various types of exercise detection devices or sensors are available for the general consumers to precisely quantify exercise and to monitor the physical conditions thereof.

Among all the exercise sensors that are currently available, a pedometer is an exercise sensor that is light and small for carrying and easy for operation and is thus widely used. A conventional pedometer is designed for carrying on the waist of a user or being attached to a shoe of a user. Besides the pedometer, an acceleration sensor is also commonly employed to detect the acceleration of a user at exercise, which is used for subsequent calculation of the exercise quantity of the user.

A variety of mechanical vibration detectors are known from prior references, such as U.S. Pat. No. 4,460,823, which discloses a pedometer for detecting treading or jogging of the user, which pedometer is composed of a pendulum, a resilient element, and gears, whereby when the user is treading or jogging, a counter shows the count of pace. U.S. Pat. No. 4,560,861 discloses a condition regulating device for meters for measuring the quantity of motion. The device comprises a pendulum for sensing vibrations, and components for transmitting the swinging of the pendulum to a display for displaying the swinging of the pendulum as a function of the quantity of motion. In addition, U.S. Pat. No. 5,117,444 discloses a pedometer structure composed of a pendulum, a magnetic element, and a reed switch for measuring the count of pace when the user is doing exercise.

The currently available pedometers often adopt mechanical vibration detection device, which often generate incorrect detection after a long term use or operation. In addition, the pendulum generally works more precisely at large vibration; otherwise the sensitivity of detection is low and incorrect counting is resulted. Further, the conventional arm-attached pedometer, as illustrated in FIG. 1, often obtains no detection signal when the arm swings in a very small range of swing amplitude. In addition, the force induced on the pedometer during the swinging of the arm is often not large enough to detect the acceleration of the arm. Further, a transmission device is needed for the arm-attached pedometer to transmit the detection result to a wristwatch that incorporates other processing or displaying device.

Another known pedometer is attached to a shoe of a user, as illustrated in FIG. 2. Attaching the pedometer to the shoe is a troublesome operation and is inconvenient. Also, a transmission device is also needed for transmitting the detected data to a wristwatch. Further, since this type of pedometer is comparatively further away from the wristwatch than the previously discussed conventional device, the transmission power must be increased. In addition, during exercise, the foot swings in two axes.

Thus, the conventional devices can only detect the pace signal caused by a single-axis or two-axis vibration of a user and there is no way to do detection of the three-axis vibration by the user at exercise. Detection of the accurate speed of walking or jogging of the user is in general not possible.

### SUMMARY OF THE INVENTION

Therefore, an objective of the present invention is to provide a wristwatch type acceleration detection module for measurement of exercise quantity.

Another objective of the present invention is to provide a wristwatch type acceleration detection module that is composed of acceleration sensors for measuring accelerations in at least two dimensions.

A further objective of the present invention is to provide a method for measuring exercise quantitatively by employing the wristwatch type acceleration detection module.

### BRIEF DESCRIPTION OF THE DRAWINGS

The present invention will be apparent to those skilled in the art by reading the following description of preferred embodiments thereof, with reference to the attached drawings, in which:

FIG. 1 is a schematic view illustrating a conventional pedometer attached to an arm of a user;

FIG. 2 is a schematic view illustrating a conventional pedometer attached to a shoe;

FIG. 3 is a schematic view illustrating a wristwatch type acceleration detection module in accordance with a first embodiment of the present invention;

FIG. 4 is a schematic view illustrating a user using the wristwatch type acceleration detection module of the present invention;

FIG. 5 is a waveform diagram showing the acceleration signals generated by the wristwatch type acceleration detection module at different hand swing angles;

FIG. 6 illustrates a swing trace of the user's hand and the associated hand swing angles;

FIG. 7 illustrates a block diagram of a control circuit of the acceleration detection module in accordance with the first embodiment of the present invention;

FIG. 8 illustrates a plot of the hand swing acceleration in X-axis with respect to the pace span of the user;

FIG. 9 illustrates a plot of the hand swing acceleration in Y-axis with respect to the pace span of the user;

FIG. 10 illustrates a plot of the hand swing acceleration in Z-axis with respect to the pace span of the user;

FIG. 11 is a flow chart showing the operation of the wristwatch type acceleration detection module of the first embodiment of the present invention;

FIG. 12 is a flow chart illustrating the establishment of a plot of hand swing acceleration with respect to the pace span in accordance with the first embodiment of the present invention;

FIG. 13 is a block diagram of a control circuit of a wristwatch type acceleration detection module in accordance with a second embodiment of the present invention;

FIG. 14 shows a plot of the pace count per second with respect to the pace span in accordance with the second embodiment;

FIG. 15 is a flow chart showing the operation of the wristwatch type acceleration detection module of the second embodiment of the present invention; and

FIG. 16 is a flow chart illustrating the establishment of a plot of pace count per second with respect to the pace span in accordance with the second embodiment of the present invention.

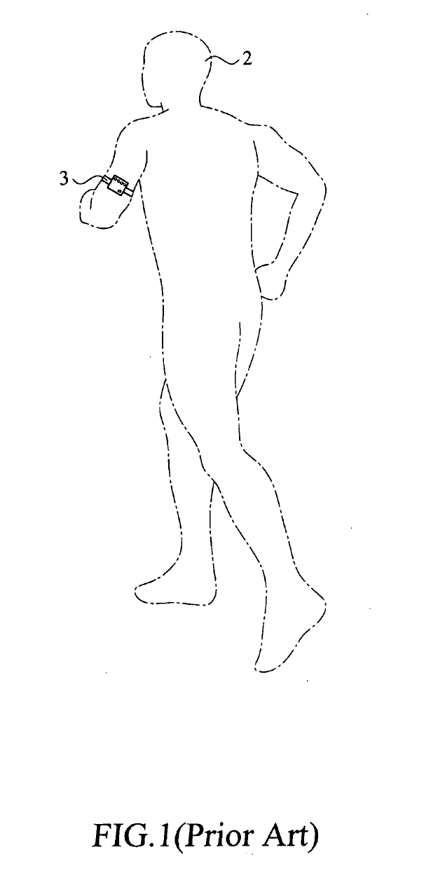

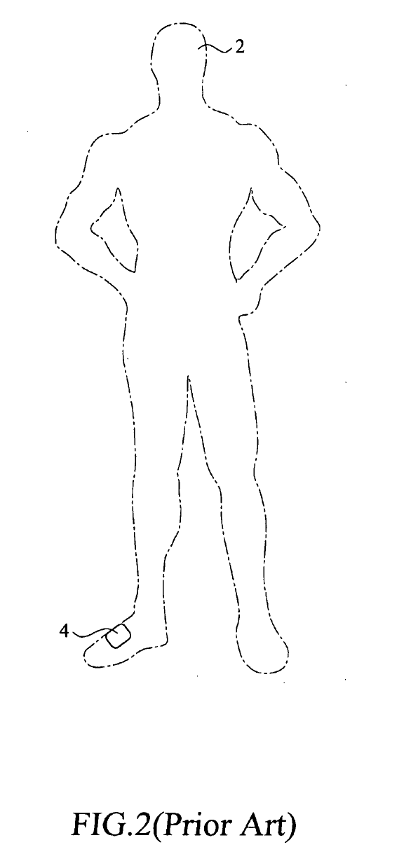

### DETAILED DESCRIPTION OF THE PREFERRED EMBODIMENTS

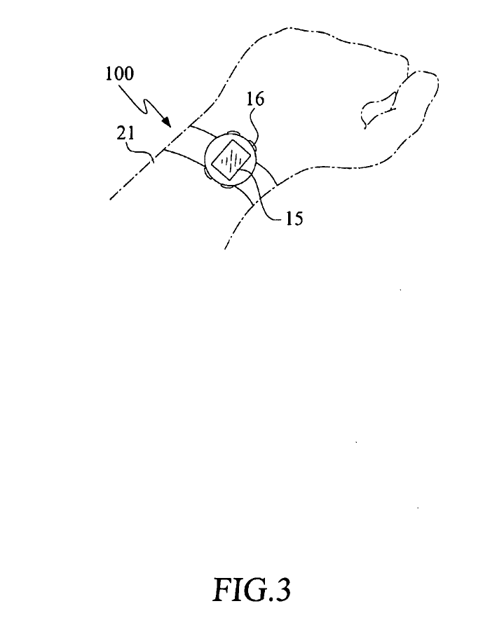

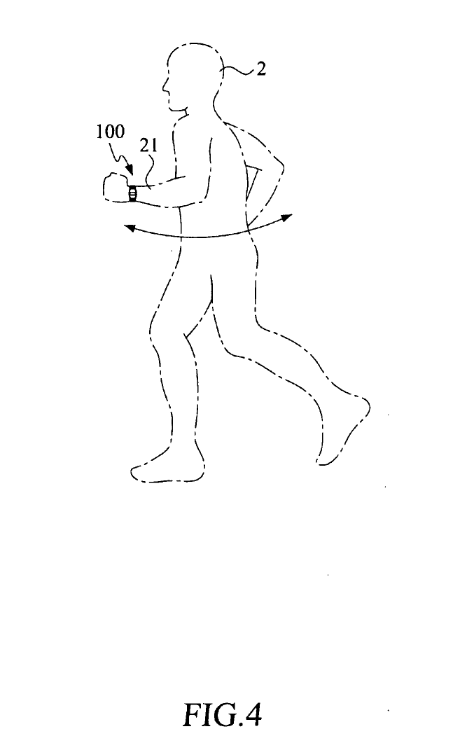

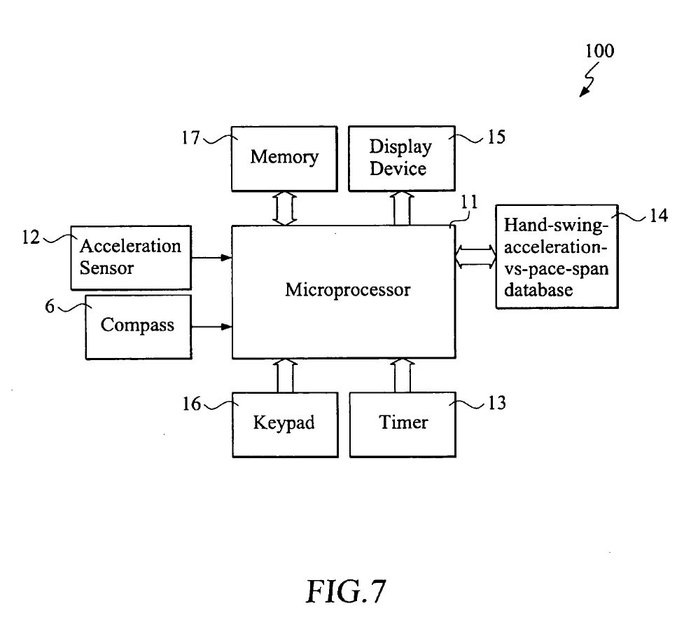

With reference to the drawings and in particular to FIGS. 3 to 7, a wristwatch type acceleration detection module constructed in accordance with a first embodiment of the present invention, generally designated with reference numeral 100, is provided for detecting the body motion of a user. The wristwatch type acceleration detection module 100 comprises a microprocessor 11, an acceleration sensor 12, a timer 13, a hand-swing-acceleration-vs-pace-span database 14, a display device 15, a keypad 16, and a memory 17. The acceleration detection module 100 of the present invention can be worn on the wrist 21 of a user or exercise taker 2. The wristwatch type acceleration detection module 100 also comprises a compass 6 for showing direction.

The acceleration sensor 12 is electrically connected to the microprocessor 11, functioning to detect the count of hand swinging (hand swing count) when the user 2 is moving and the acceleration induced by the swing of the hand (hand swing acceleration) and to transmit the detected hand swing count and the hand swing acceleration to the microprocessor 11. The acceleration sensor 12 may comprise a one-dimensional, two-dimensional, or three-dimensional acceleration detection device.

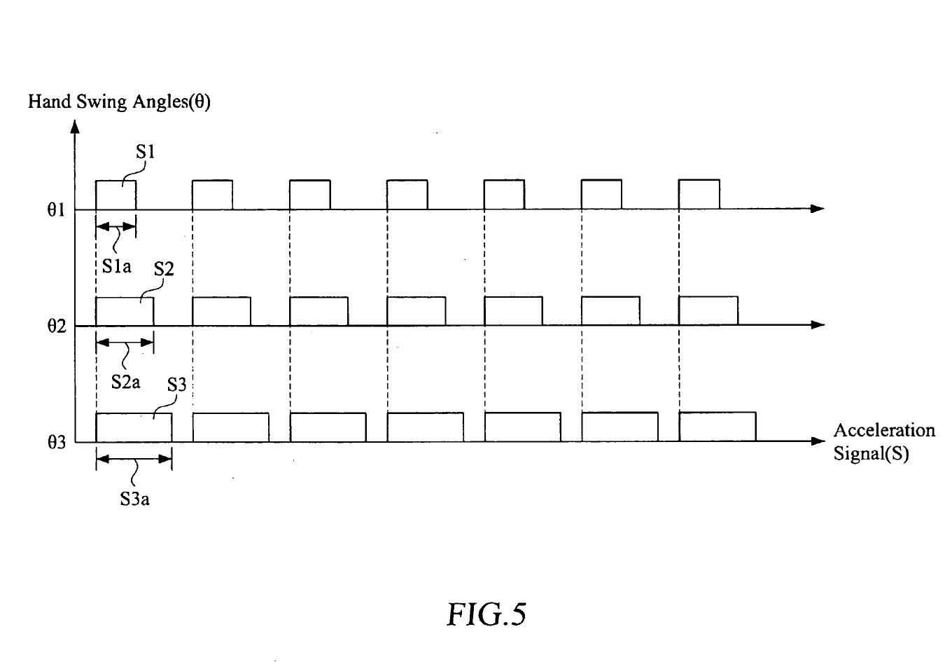

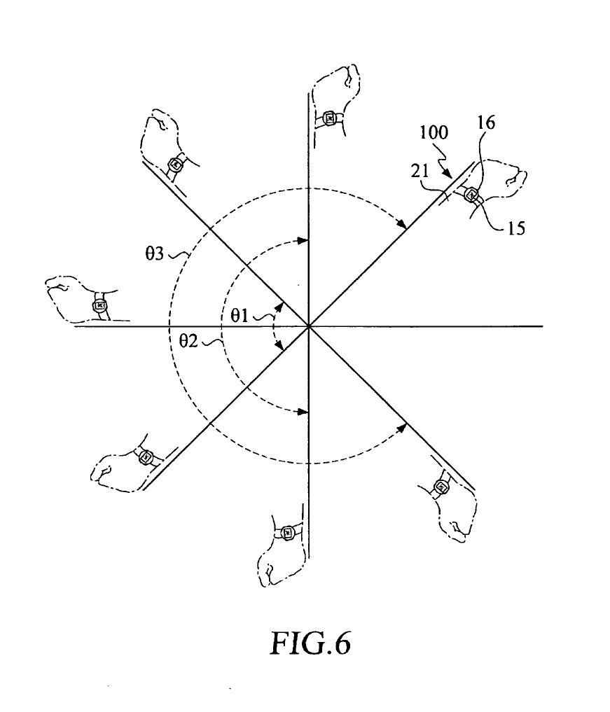

A large hand swing angle (θ) of the user 2 indicates that the speed of swing of the hand is great, which generates a large acceleration signal (S), as showed in FIGS. 5 and 6. For example, when the user 2 is moving at a low speed, the hand swings an angle θ1 and a corresponding acceleration signal S1 is induced by the swing of the hand. When the user 2 moves at a moderate speed, the hand swings an angle θ2 and an acceleration signal S2 is generated by the swing of the hand. When the user 2 moves at high speed, the hand swings an angle of θ3 and an acceleration signal S3 is generated by the hand swinging. The acceleration signal S3 has an active signal length S3a, which is greater than an active signal length S2a of the acceleration signal S2; and the active signal length S2a of the acceleration signal S2 is greater than an active signal length S1a of the acceleration signal S1. And, the hand swing angle θ3 is greater than the hand swing angle θ2, which is in turn greater than the hand swing angle θ1.

As shown in FIG. 6, since the position and trace of hand swing of the user 2 may be composed of components in either one-dimensional, two-dimensional or three-dimensional swing axes, the acceleration sensor 12 may comprise one-dimensional, two-dimensional, or three-dimensional acceleration detection unit or device. Thus, the present invention is capable to correctly detect the hand swing counts of the user 2 even when the trace of hand swing of the user 2 contains displacement in more than one dimension.

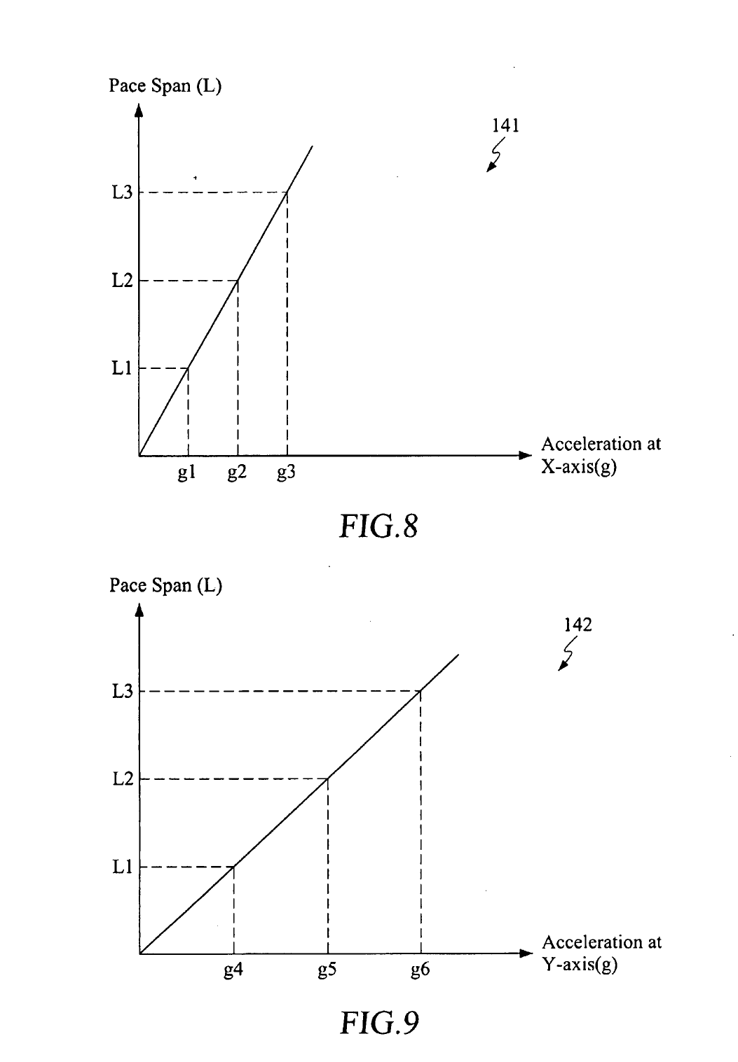

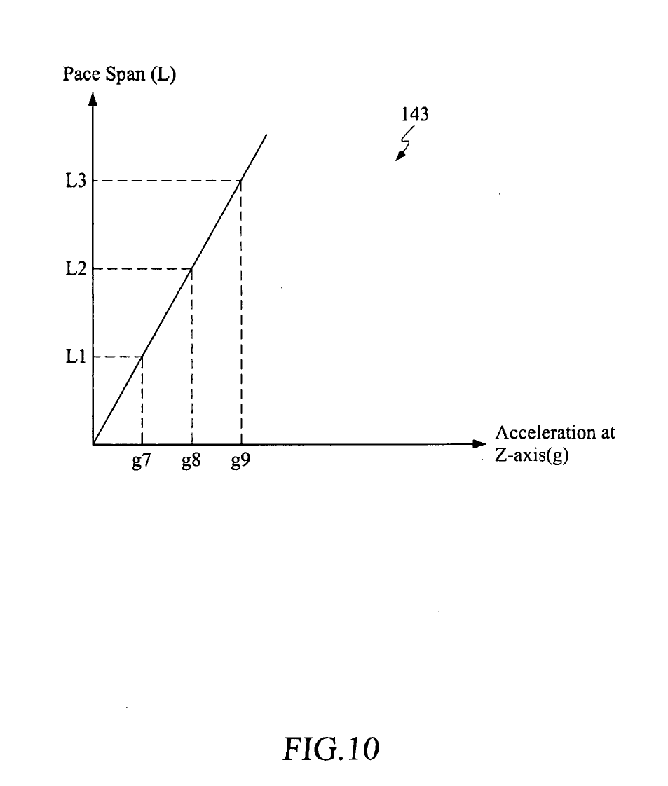

Please refer to FIGS. 8 to 10. The timer 13 is electrically connected to the microprocessor 11 for measuring the time period when the user 2 is in movement and transmitting the measurement to the microprocessor 11. The hand-swing-acceleration-vs-pace-span database 14 is electrically connected to the microprocessor 11 and stores a plot 141 (as shown in FIG. 8) indicating the relationship between the acceleration of hand swinging in X-axis and the pace span (a plot of the hand swing acceleration vs. the pace span), a plot 142 (as shown in FIG. 9) indicating the relationship between the acceleration of hand swinging in Y-axis and the pace span, and a plot 143 (as shown in FIG. 10) indicating the relationship between the acceleration of hand swinging in Z-axis and the pace span.

Please refer to FIGS. 8 to 10. The microprocessor 11 compares the hand swing acceleration acquired through the acceleration sensor 12 with the plots 141, 142, 143 respectively associated with the X-axis, Y-axis, Z-axis hand swing acceleration with respect to the pace span stored in the hand-swing-acceleration-vs-pace-span database 14 to determine the pace span of the user 2 in movement corresponding to the hand swing acceleration of the user 2.

As illustrated in FIGS. 8 to 10, when the user 2 swings the hand at low speed, which induces an acceleration g1 in the X-axis, an acceleration g4 in the Y-axis, and an acceleration g7 in the Z-axis, all being induced by the same swing movement, the accelerations g1, g4, g7 are all correlated to the same pace span L1. When the user 2 swings the hand in a moderate speed, which induces an acceleration g2 in the X-axis, an acceleration g5 in the Y-axis, and an acceleration g8 in the Z-axis, since all the accelerations are induced by the same swing movement, all the accelerations g2, g5, g8 are correlated to the same pace span L2. When the user 2 swings the hand in a high speed, which induces an acceleration g3 in the X-axis, an acceleration g6 in the Y-axis, and an acceleration g9 in the Z-axis, since all the accelerations are induced by the same swing movement, all the accelerations g3, g6, g9 are correlated to the same pace span L3.

The microprocessor 11 calculates the moving distance and moving speed of the user 2 by predefined formula on the basis of the acquired pace span of the user 2 in movement, the hand swing counts of the user 2, and the period of time of movement of the user 2, and then displays the moving distance and moving speed on the display device 15.

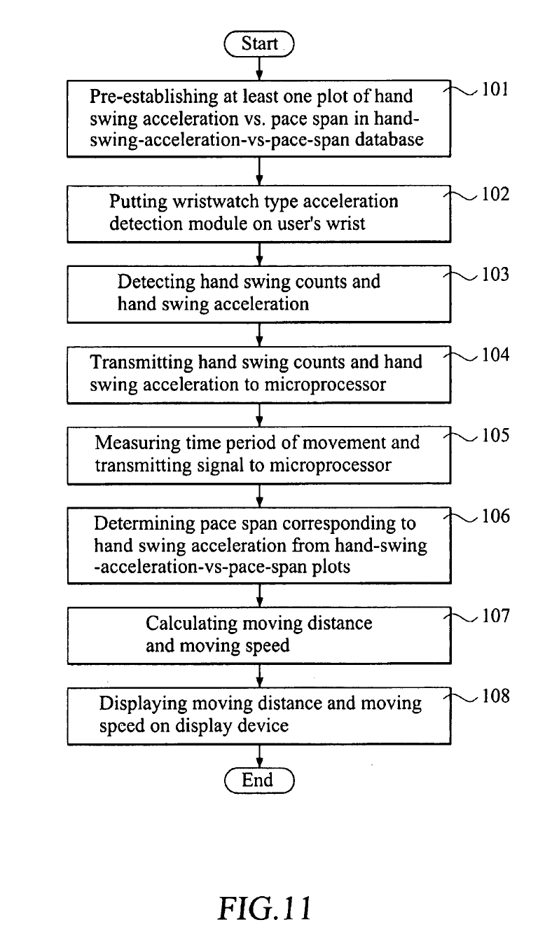

FIG. 11 demonstrates a flow chart of the operation the present inventive device in accordance with a first embodiment thereof. In step 101, at least one plot of hand swing acceleration vs. pace span is pre-established and stored in the hand-swing-acceleration-vs-pace-span database of a wristwatch type acceleration detection module. In step 102, the user puts the wristwatch type acceleration detection module on his or her hand and the user starts to exercise.

The acceleration detection of the wristwatch type acceleration detection module detects the hand swing counts and the hand swing acceleration when the user is in movement (step 103). The hand swing counts and the hand swing acceleration detected by the acceleration sensor are then transmitted to the microprocessor of the wristwatch type acceleration detection module (step 104) and the time period during which the user is in movement is measured by the timer of the wristwatch type acceleration detection module and is transmitted to the microprocessor (step 105).

The microprocessor then computes the pace span corresponding to the hand swing acceleration based on the hand swing acceleration previously acquired and the hand-swing-acceleration-vs-pace-span plots stored in the hand-swing-acceleration-vs-pace-span database (step 106).

The microprocessor further calculates the moving distance and the moving speed based on the pace span, the hand swing counts, and the time period of movement in accordance with predetermined formula (step 107), and finally, the microprocessor displays the moving speed so obtained on the display device (step 108).

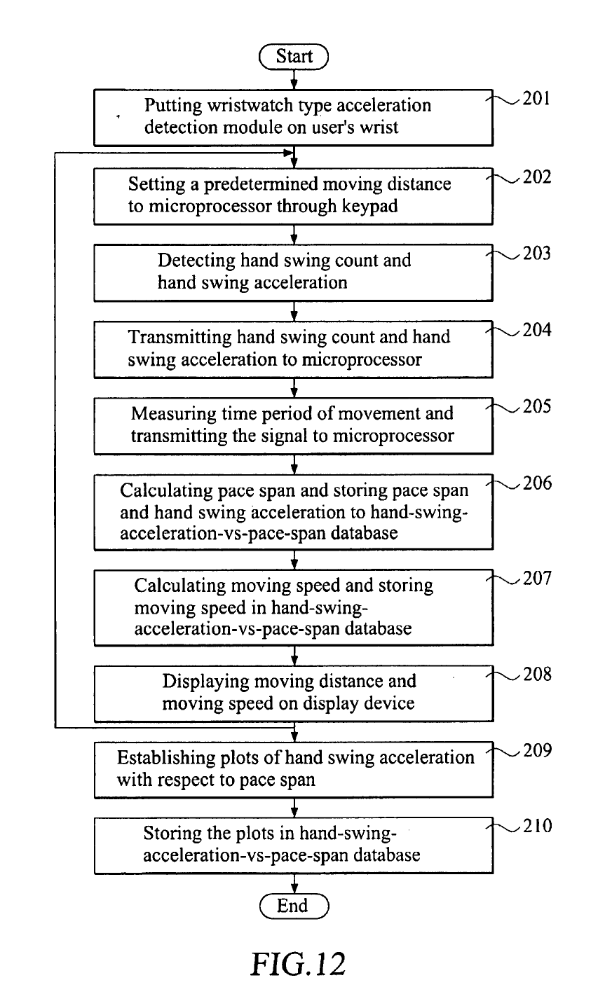

In accordance with the present invention, the hand-swing-acceleration-vs-pace-span plots are previously built in the hand-swing-acceleration-vs-pace-span database. Preferably, these hand-swing-acceleration-vs-pace-span plots can be alternately established through actual movement of the user at different speeds through a predetermined moving distance and this is demonstrated in FIG. 12.

First of all, the user wears the wristwatch type acceleration detection module on his or her wrist (step 201), and the user enters a predetermined moving distance into the microprocessor through the keypad (step 202). After that, the user starts to move with a low speed.

Thereafter, the acceleration sensor detects the hand swing count and the hand swing acceleration in the low speed movement (step 203). The acceleration sensor then transmits the hand swing count and the hand swing acceleration to the microprocessor (step 204). And, the timer measures the time period of movement that the user takes to move through the predetermined distance at the low speed and transmits the measurement to the microprocessor (step 205).

The processor then divides the predetermined moving distance by the hand swing count to obtain the pace span of the user who is moving in the low speed. The pace span and the hand swing acceleration of the low speed movement of the user are then stored to the hand-swing-acceleration-vs-pace-span database (step 206).

The microprocessor then divides the predetermined moving distance by the time period of movement to obtain the moving speed of the low speed movement, which is then stored in the hand-swing-acceleration-vs-pace-span database (step 207). The microprocessor then displays the moving speed of the low speed movement on the display device (step 208).

Steps 202 to 208 are repeated again, and this time the user moves at a moderate speed. And then steps 202 to 208 are further repeated with the user moving at a high speed. If desired, the user may further establish data related to an extremely high speed movement, steps 202 to 208 may once again repeated. Thereafter, the microprocessor establishes plots of hand swing acceleration vs. pace span based on the hand swing accelerations and the related pace spans of the user stored in the hand-swing-acceleration-vs-pace-span database (step 209). Finally, the microprocessor stores the hand-swing-acceleration-vs-pace-span plots to the hand-swing-acceleration-vs-pace-span database (step 210).

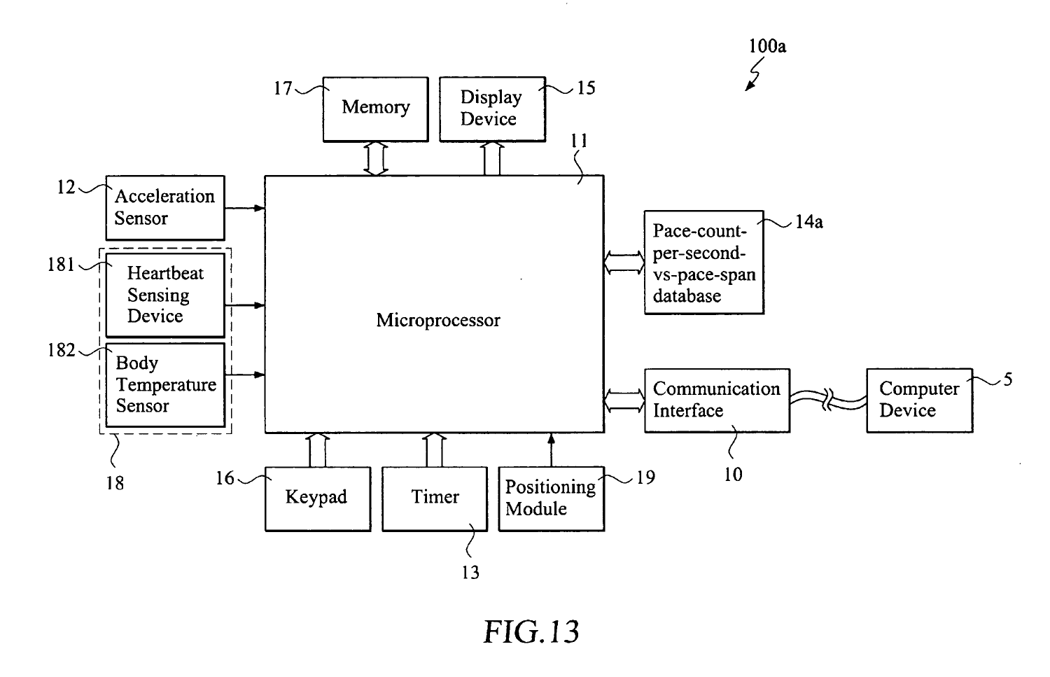

With reference to FIG. 13, which illustrates a control circuit according to a second embodiment of the present invention, generally designated with reference numeral 100a, the control circuit of the second embodiment 100a is substantially similar to the previous embodiment, and similar or identical parts/devices are designated with the same reference numerals. The difference between the instant embodiment and the previous one resides in that in the second embodiment 100a employs a pace-count-per-second-vs-pace-span database 14a to replace the hand-swing-acceleration-vs-pace-span database 14 of the first embodiment. The pace-count-per-second-vs-pace-span database 14a stores at least one plot 141a of the pace count per second vs. the corresponding pace span. Also, the acceleration sensor 12 in the second embodiment only detects and transmits the hand swing count to the microprocessor 11.

The microprocessor 11, upon receiving the hand swing count from the acceleration sensor 12 and the time period of movement measured by the timer 13, divides the hand swing count by the time period of movement to obtain the pace count per second of the user 2. The microprocessor 11 then compares the pace count per second so acquired with the pace-count-per-second-vs-pace-span plots 141a stored in pace-count-per-second-vs-pace-span database 14a to obtain the pace span of the user 2 corresponding to the pace count per second.

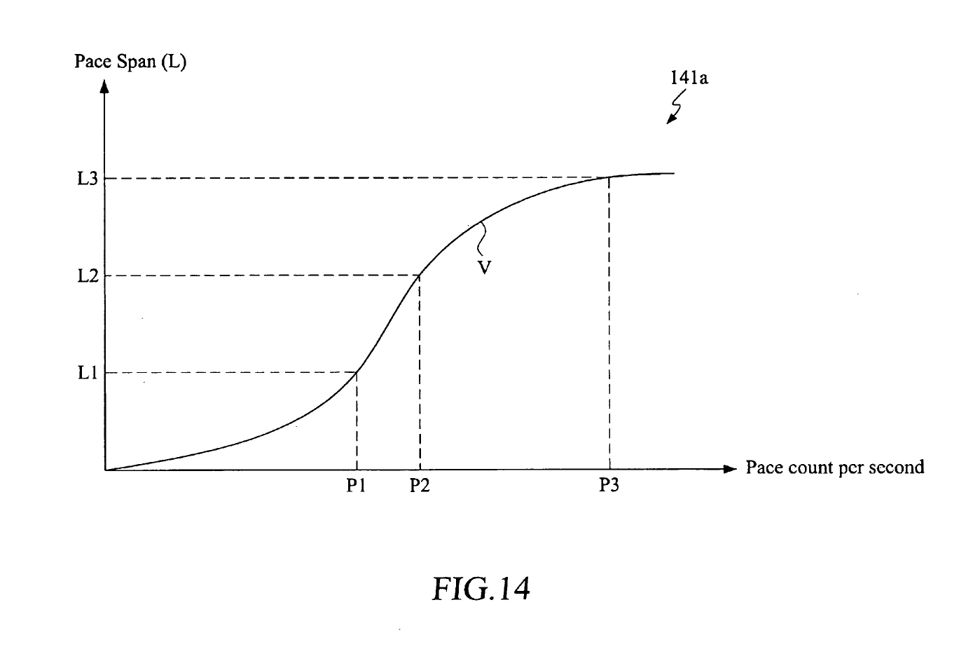

As shown in FIG. 14, the pace-count-per-second-vs-pace-span database 141a contains a curve V in which for a user 2 moves in a pace count per second of P1, the curve V indicates that the pace span of the user 2 is L1. If the user 2 is moving with a pace count per second of P2, then the curve V indicates the pace span of the user 2 is L2. Similarly, when the user 2 is moving with a pace count per second of P3, then the pace span of the user 2 is L3, as indicated by the curve V.

The microprocessor 11 then performs computation based on the pace span, the hand swing count, and the time period of movement of the user 2 to obtain the moving distance and the moving speed of the user 2 and displays the moving speed of the user 2 on the display device 15.

The wristwatch type acceleration detection module constructed in accordance with the second embodiment further comprises a body motion detecting module 18, a positioning module 19 and a communication interface 10. The body motion detecting module 18 comprises a heartbeat sensing device 181 and a body temperature sensor 182. The heartbeat sensing device 181 detects a heartbeat signal of the user, and the body temperature sensor 182 detects a body temperature of the user. The heartbeat signal and the body temperature signal are transmitted to the microprocessor 11.

The positioning module 19 is used to detect the altitude of the user and the signal is transmitted to the microprocessor 11. The communication interface 10 is connected between the microprocessor 11 and a computer device 5 for transmitting data therebetween.

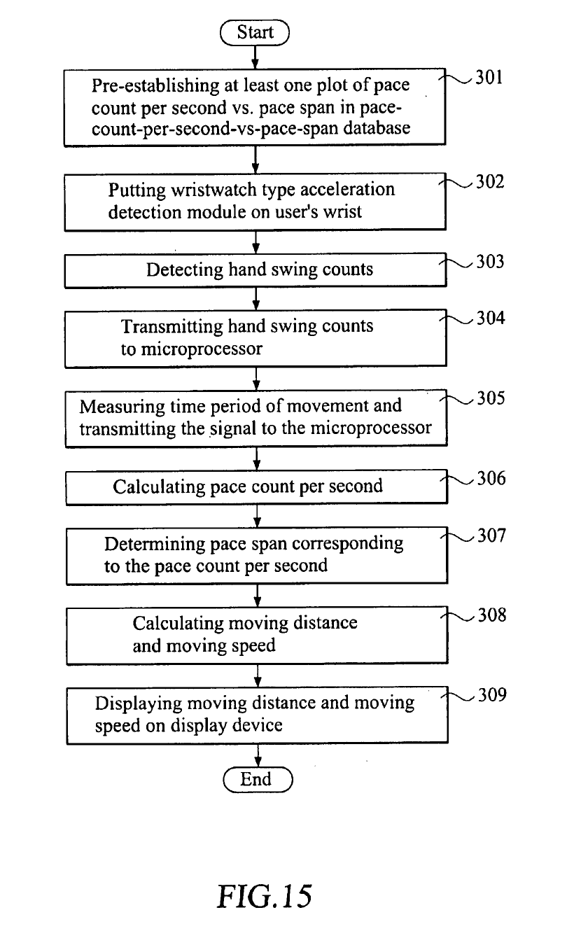

FIG. 15 is a flow chart demonstrating the flow of operation of the second embodiment. First of all, in step 301, at least one plot of pace count per second vs. pace span is pre-established and stored in the pace-count-per-second-vs-pace-span database of the wristwatch type acceleration detection module. In step 302, the user puts the wristwatch type acceleration detection module on his or her hand and the user starts to exercise.

The acceleration sensor of the wristwatch type acceleration detection module detects the hand swing count when the user is in movement (step 303). The hand swing count detected by the acceleration sensor is then transmitted to the microprocessor (step 304) and the time period in which the user is in movement measured by the timer is also transmitted to the microprocessor (step 305).

The microprocessor then divides the hand swing count by the time period of movement to obtain the pace count per second of the user (step 306).

The microprocessor computes the pace span corresponding to the pace count per second based on the pace count per second previously acquired and the pace-count-per-second-vs-pace-span plots stored in the pace-count-per-second-vs-pace-span database (step 307).

The microprocessor further calculates the moving distance and the moving speed based on the pace span, the hand swing count, and the time period of movement in accordance with predetermined formula (step 308), and finally, the microprocessor displays the moving speed so obtained on the display device (step 309).

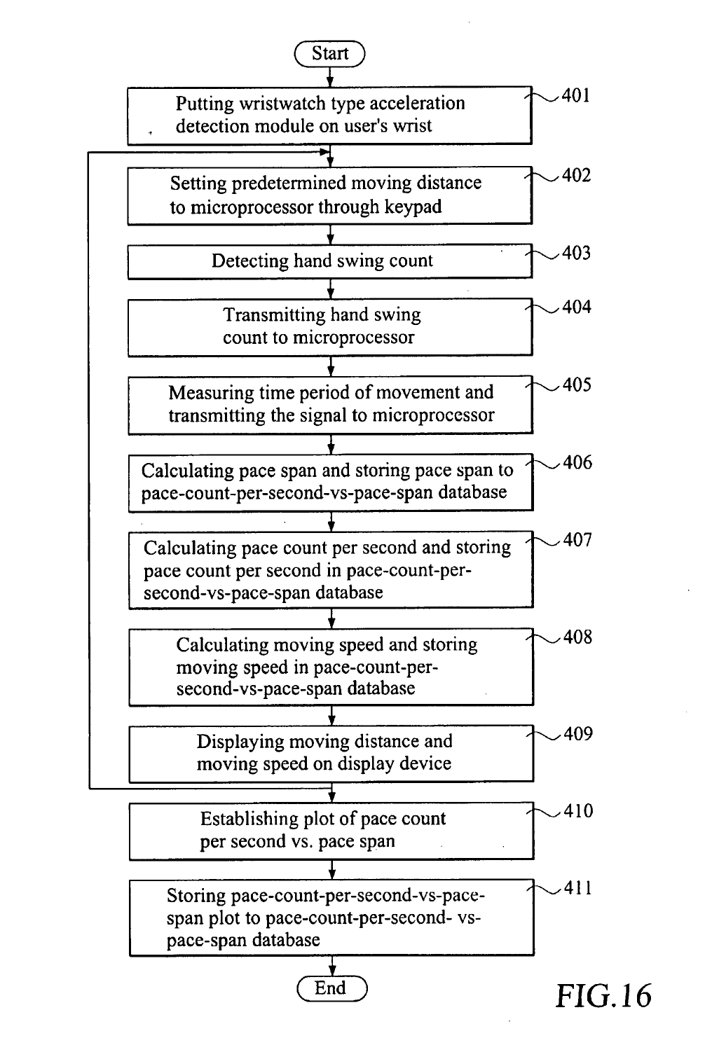

In accordance with the second embodiment of the present invention, the pace-count-per-second-vs-pace-span plot 141a may be previously built in the pace-count-per-second-vs-pace-span database 14a. Preferably, the pace-count-per-second-vs-pace-span plot 141a can be alternately established through actual movement of the user with different speeds through a predetermined moving distance and this is demonstrated in FIG. 16.

First of all, the user wears the wristwatch type acceleration detection module 100a on his or her wrist (step 401), and the user enters a predetermined moving distance into the microprocessor through the keypad (step 402). After that, the user starts to move with a low speed.

Thereafter, the acceleration sensor detects the hand swing count in the low speed movement (step 403). The acceleration sensor then transmits the hand swing count to the microprocessor (step 404). And, the timer measures the time period of movement that the user takes to move through the predetermined distance with the low speed and transmits the measurement to the microprocessor (step 405).

The processor then divides the predetermined moving distance by the hand swing count to obtain the pace span of the user who is moving in the low speed. The pace span of the low speed movement of the user is then stored to the pace-count-per-second-vs-pace-span database (step 406).

The microprocessor then divides the hand swing count by the time period of movement to obtain the pace count per second of the low speed movement of the user, which is then stored in the pace-count-per-second-vs-pace-span database (step 407).

The microprocessor then divides the predetermined moving distance by the time period of movement to obtain the moving speed of the low speed movement, which is then stored in the pace-count-per-second-vs-pace-span database (step 408). And the microprocessor displays the moving speed of the low speed movement on the display device (step 409).

Steps 402 to 409 are repeated again, and this time the user moves with a moderate speed. And then steps 402 to 409 are further repeated, in which the user moves with a high speed. If desired, the user may further establish data related to an extremely high speed movement, and steps 402 to 409 are once again repeated. Thereafter, the microprocessor establishes a plot of pace count per second vs. pace span based on the pace count per second and the related pace span of the user that are stored in the pace-count-per-second-vs-pace-span database (step 410). And finally, the microprocessor stores the pace-count-per-second-vs-pace-span plot to the pace-count-per-second-vs-pace-span database (step 411).

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A wristwatch type acceleration detection module, the module comprising:
a microprocessor;
an acceleration sensor, electrically connected to the microprocessor and detecting a hand swing count of the user in movement and transmitting the detected hand swing count to the microprocessor;
a timer, electrically connected to the microprocessor and measuring a time period when the user is in movement and transmitting the time period of movement to the microprocessor;
an exercise-data-vs-pace-span database, electrically connected to the microprocessor and storing at least one exercise-data-vs-pace span plot; and
a display device, electrically connected to the microprocessor.

2. The wristwatch type acceleration detection module as claimed in claim 1, wherein the exercise-data-vs-pace-span plot is established in the exercise-data-vs-pace-span database in advance.

3. The wristwatch type acceleration detection module as claimed in claim 1 further comprising a keypad electrically connected to the microprocessor to allow the user to set a predetermined moving distance, such that the exercise-data-vs-pace-span plot is established by actual movements of the user with different moving speeds through the predetermined moving distance, and the microprocessor divides the predetermined moving distance by the hand swing counts of the user at different speed movements to obtain corresponding pace spans associated with the different moving speeds, and the exercise-data-vs-pace-span plot is stored to the exercise-data-vs-pace-span database.

4. The wristwatch type acceleration detection module as claimed in claim 1, wherein the exercise-data-vs-pace-span database comprises a hand-swing-acceleration-vs-pace-span database, and the stored exercise-data-vs-pace-span plot comprises a hand-swing-acceleration-vs-pace-span plot.

5. The wristwatch type acceleration detection module as claimed in claim 4, wherein the hand-swing-acceleration-vs-pace-span plot comprises at least one plot of hand swing acceleration in X-axis with respect to the pace span.

6. The wristwatch type acceleration detection module as claimed in claim 4, wherein the hand-swing-acceleration-vs-pace-span plot comprises at least one plot of hand swing acceleration in X-axis with respect to the pace span and one plot of hand swing acceleration in Y-axis with respect to the pace span.

7. The wristwatch type acceleration detection module as claimed in claim 4, wherein the hand-swing-acceleration-vs-pace-span plot comprises at least one plot of hand swing acceleration in X-axis with respect to the pace span, one plot of hand swing acceleration in Y-axis with respect to the pace span, and one plot of hand swing acceleration in Z-axis with respect to the pace span.

8. The wristwatch type acceleration detection module as claimed in claim 4, wherein the acceleration sensor detects the hand swing count of the user in movement and acceleration induced by hand swinging and transmits the detected hand swing count and the hand swing acceleration to the microprocessor.

9. The wristwatch type acceleration detection module as claimed in claim 8, wherein the microprocessor compared the hand swing acceleration with the hand-swing-acceleration-vs-pace-span plot stored in the hand-swing-acceleration-vs-pace-span database to obtain the pace span of the user in movement corresponding to the hand swing acceleration, and further computes a moving distance and a moving speed of the user through predetermined formula based on the pace span, the hand swing count, and the time period of movement of the user and then displays the moving distance and the moving speed on the display device.

10. The wristwatch type acceleration detection module as claimed in claim 1, wherein the exercise-data-vs-pace-span database comprises a pace-count-per-second-vs-pace-span database, in which the stored exercise-data-vs-pace-span plot comprises a pace-count-per-second-vs-pace-span plot.

11. The wristwatch type acceleration detection module as claimed in claim 10, wherein the microprocessor divides the received hand swing count by the time period of movement to obtain pace count per second of the user and compares the pace count per second so obtained with the pace-count-per-second-vs-pace-span plot stored in the pace-count-per-second-vs-pace-span database to obtain the pace span corresponding to the pace count per second and further computes a moving distance and a moving speed of the user through predetermined formula based on the pace span, the hand swing count, and the time period of movement of the user and then displays the moving distance and the moving speed on the display device.

12. The wristwatch type acceleration detection module as claimed in claim 1, wherein the acceleration sensor comprises a single-axis acceleration sensor.

13. The wristwatch type acceleration detection module as claimed in claim 1, wherein the acceleration sensor comprises an X-axis acceleration sensor and a Y-axis acceleration sensor.

14. The wristwatch type acceleration detection module as claimed in claim 1, wherein the acceleration sensor comprises an X-axis acceleration sensor, a Y-axis acceleration sensor, and a Z-axis acceleration sensor.

15. The wristwatch type acceleration detection module as claimed in claim 1, further comprising a body motion detecting module.

16. The wristwatch type acceleration detection module as claimed in claim 15, wherein the body motion detecting module comprises a heartbeat sensing device for detecting a heartbeat signal of the user.

17. The wristwatch type acceleration detection module as claimed in claim 15, wherein the body motion detecting module comprises a body temperature sensor for detecting a body temperature of the user.

18. The wristwatch type acceleration detection module as claimed in claim 1, further comprising a compass.

19. The wristwatch type acceleration detection module as claimed in claim 1, further comprising a communication interface, which is connected between the microprocessor and a computer device for transmitting data therebetween.

20. The wristwatch type acceleration detection module as claimed in claim 1, further comprising a positioning module for detecting the altitude of the user.
